(19) United States
(12) Patent Application Publication
(10) Pub. No.: US 2025/0149919 A1
(43) Pub. Date: May 8, 2025

(54) WIRELESS POWERED HUMIDIFIER AND CONTROL SYSTEM

(71) Applicant: Helen of Troy Limited, St. Michael (BB)

(72) Inventors: Kevin M. Johnson, Natick, MA (US); Paul C. M. Hilton, Millis, MA (US); Yuli A. Starodubtsev, Hampstead, NC (US); Stuart E. Ross, Wilmington, NC (US)

(21) Appl. No.: 18/838,309

(22) PCT Filed: Feb. 17, 2023
(86) PCT No.: PCT/US2023/013289

§ 371 Date: Aug. 14, 2024

Related U.S. Application Data
(60) Provisional application No. 63/312,494, filed on Feb. 22, 2022.

(51) Int. Cl. H02J 50/10; F24F 6/00; F24F 6/02; F24F 6/12; H02J 50/90

(52) U.S. Cl. CPC H02J 50/10; F24F 6/025; F24F 6/12; H02J 50/90; F24F 2006/008

(57) ABSTRACT

A humidifier includes a water tank, a humidifying module, a wireless power transmitter and a transport mechanism. The humidifying module is positionable in the water tank, and includes a wireless power receiver and at least one of an ultrasonic transducer and a heating element in electrical communication with the wireless power receiver. The wireless power transmitter is configured to wirelessly transmit electrical power through a wall of the water tank to the wireless power receiver. The transport mechanism configured to move the wireless power transmitter with respect to the water tank.

### BACKGROUND

Conventional humidifiers are generally designed to increase humidity in a room, building, or similar enclosed space by one of three means: directing airflow through a wicking element placed in a water reservoir (also known as evaporative humidification), boiling water locally around a heating element to create steam (also known as warm mist humidification) or atomizing water into tiny droplets and entraining them into moving air (also known as cool mist or ultrasonic humidification). There a number of problems associated with these designs that are fundamental to their architecture. These problems include leaking, spillage, and cleaning, among others. These problems are related to and exacerbated by the typical configuration where water is filled and stored in one container (a tank), and metered into a tray of standing water into which the evaporative element is located. To control release of water from the tank to the tray, known water tanks are equipped with a float valve mechanism configured for maintaining a water level in the tray and causing the tank to release water to the tray when the water level in the tray lowers to a predetermined level. In alternative known humidifiers, the water tank is positioned with the tray such that a lowest fluid outlet of the water tank is submerged in water when the water level in the tray reaches a predetermined level, obstructing further release of water from the tank to the tray, where the tank retains water elevated above the tray due to vacuum pressure.

With the open design of the reservoir, the reservoir can be prone to spilling water around the humidifier, including on the fan and any other electronic components in the humidifier. The known reservoir or “tray” of water is invisible to a user, concealed behind plastic walls, and has “nooks and crannies” required for moldability and function such that walls of the reservoir make it difficult to clean slime, residue, and biological growth that build up over time. When cleaning traditional humidifiers, users need to disassemble the humidifier to access and clean the water reservoir. Also, because water is metered into a reservoir in traditional humidifiers, there are seals, valves and/or floats that are sources of leakage and failure in the humidifier. Finally, the removable tank in traditional humidifiers is prone to dripping when removed.

Referring to FIG. 1, in a conventional ultrasonic humidifier 20, one can readily see the complex geometry to accommodate the function of the humidifier. The conventional ultrasonic humidifier 20 includes a water tank 22, a tank lid 24 covering the tank and defining a mist outlet 26. The conventional ultrasonic humidifier 20 also includes a fan 26 and an transducer 28. The tank 22 sits on a lower water tray 32 in which a float valve mechanism 34 is provided and the water level 36 in the lower water tray 32 is shown in FIG. 1. Mist exits through a chimney 38 and the mist exit 26. In particular, in the lower water tray 32, where water can stand, invisibly, for extended periods, there are a number of features and parts that a user has to clean around. In order for the transducer 28 to optimally atomize the water and create a plume of mist, the water height above the transducer 28 needs to be maintained. The standing, invisible water becomes promotes microbial growth and makes this particularly unpleasant for the user. Finally, this area of the humidifier 20 is only accessible if the water tank 22 is pulled from the unit. It also has electronics, power converters and the fan 26, so care has to be taken to make sure those components do not get wet, i.e. the conventional ultrasonic humidifier is not suitable to being placed in a sink.

The float and valve mechanism 34 and associated float linkage 42 and seal(s) 44 shown in FIG. 2 create additional complexity that the user has to clean around. If the seal to the water tank 22 fails, the lower water tray 32 can overflow, damaging floors, carpets or table surfaces.

FIG. 3 shows an isometric view of the base of the conventional ultrasonic humidifier, including the lower water tray 32 and other main components. As can readily be seen, there are a number of components and features around which a user has to clean. This humidifier base cannot be brought to a tub or sink to clean, because there is an opening 46 for the fan 26 and the entire base is powered directly from a wall outlet through a power cord 48. Practically speaking, it can only be wiped cleaned.

### SUMMARY

In view of the foregoing, a humidifier includes a water tank, a humidifying module, a wireless power transmitter and a transport mechanism. The humidifying module is positionable in the water tank, and includes a wireless power receiver and at least one of an ultrasonic transducer and a heating element in electrical communication with the wireless power receiver. The wireless power transmitter is configured to wirelessly transmit electrical power through a wall of the water tank to the wireless power receiver. The transport mechanism configured to move the wireless power transmitter with respect to the water tank.

### BRIEF DESCRIPTION OF THE DRAWINGS

FIG. 1 is an overall view of a conventional ultrasonic humidifier.

FIG. 2 is a section of the float/metering mechanism in the conventional humidifier depicted in FIG. 1.

FIG. 3 is an isometric view of a water tray for the conventional ultrasonic humidifier.

FIG. 4 is an overall view of a new humidifier.

FIG. 5 is an exploded view of the humidifier depicted in FIG. 4.

FIG. 6 shows a schematic cross section of the humidifier depicted in FIG. 4.

FIG. 7 is a top view of a humidifying module and alignment track for the humidifier depicted in FIG. 4.

FIG. 8 is graphic showing methods for delivering power wirelessly.

FIG. 9 shows a representative inductive transmitter and receiver with ferrite cores.

FIG. 10 depicts a warm mist humidifying module for a new humidifier.

FIG. 11 depicts the humidifier depicted in FIG. 4 with lighting.

FIG. 12 depicts the humidifier depicted in FIG. 4 focused on exit plume illumination.

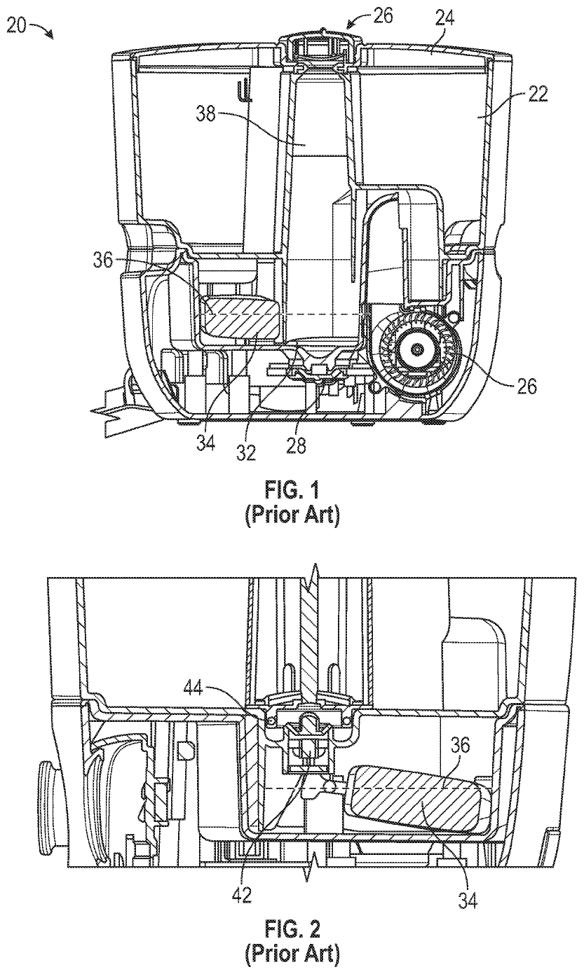

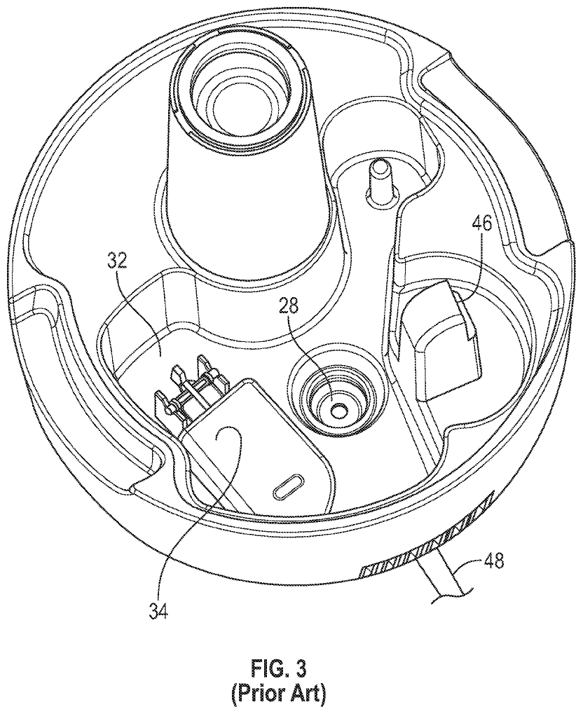

### DETAILED DESCRIPTION

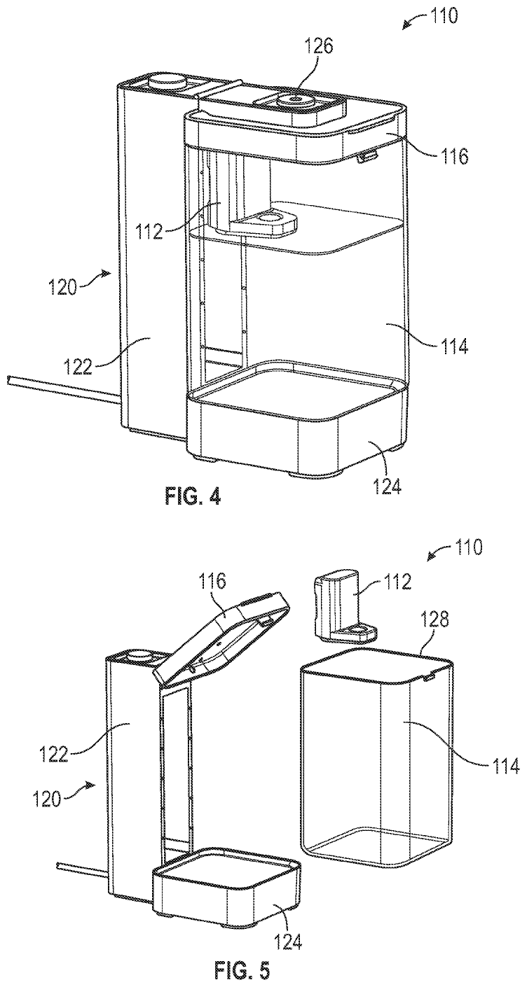

Referring to FIG. 4, a humidifier 110 is shown where a humidifying module 112 is wirelessly powered and moves with respect to the water level in a water tank 114, instead of the water being delivered to a fixed humidifying element. The wireless delivery of power to the humidifying module 112, combined with the humidifying module 112 maintaining the optimal depth with respect to the water level results in a humidifier 110 where there is one tank that holds water, i.e., the water tank 114, and other than the humidifying module 112 and a lid 116 for the water tank 116, is the only part that gets wet. There are no seals nor valves associated with a water path to disconnect when cleaning. The humidifier architecture lends itself to water tanks of virtually any capacity or depth.

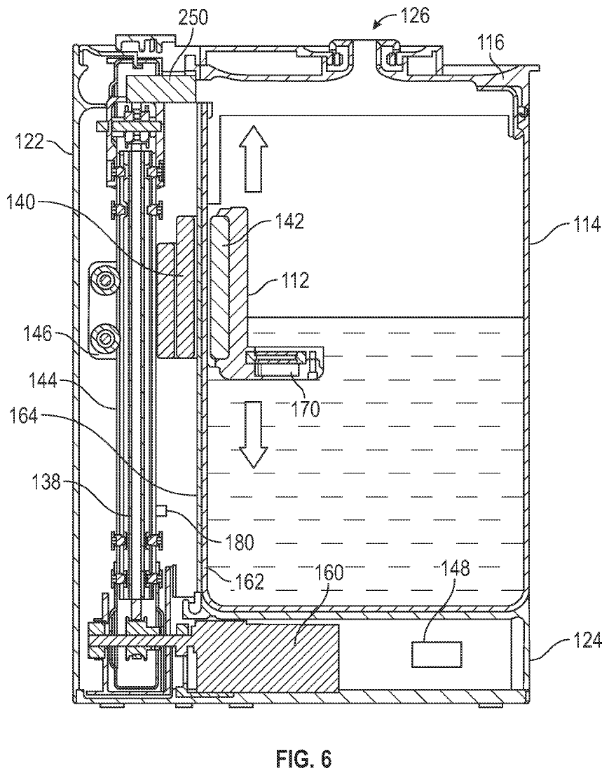

Referring to FIGS. 4 and 5, the humidifier 110 includes a housing 120 including a transport column 122 and a base 124, upon which the water tank 114 is positioned in the illustrated embodiment. The rotatable or removable lid 116 includes a vapor exit opening 126. The lid 116 selectively covers the water tank 114 and contacts an upper edge 128 of the water tank 114 when covering the water tank 114. When a rotatable lid 116 is provided, the rotatable lid 116 is pivotally connected with the transport column 122. The humidifier 110 also includes the transport column 122, which houses a vertical transport mechanism 138 (FIG. 6) carrying a wireless power transmitter 140 that can wirelessly drive power to the humidifying module 112, which has the ability to receive the wireless power and to convert the received power to either mechanical or heat energy.

The vertical transport of a wireless power receiver 142 and the humidifying module 112 (i.e. along the Z axis) is accomplished through the vertical transport mechanism 138 which can include a belt, cable, gear rack, screw or any other means used for the linear transport of components. With reference to FIG. 6, the vertical transport mechanism can include a frame 144 that carries belt, cable, or screw. The wireless power transmission elements in the transport column 122 may be attached to or integrated in a carriage 146, which can include wheels or other low-friction sliding elements or mechanisms, e.g. Teflon® coated part, Delrin® components, ball bearings, to contain and constrain the power transmission elements and their position (X, Y and Z and their rotation about these axis). These constraints may be accomplished through a track and/or features integral to the transport column itself. The vertical transport mechanism 138 may also include means for determining at least one position of the wireless power transmitter in its “Z” travel (e.g. limit switches, encoders, sensors) such that its “Z” position in the transport column 122 can be determined or estimated.

The position of the vertical transport of the wireless power transmitter 140 and the carriage 146 is determined by and controlled by a controller 148, e.g., a microprocessor, with input from the aforementioned means (e.g. limit switches, encoders, sensors) for determining at least one position of the wireless power transmitter 140, via a means for moving the wireless power elements and the carriage—e.g. a rotary or linear motor 160, which can be located in the base 124 (as shown in FIG. 6) or in the transport column 122.

The power that is transferred to the humidifying module 112 may also be used for other functions, including but not limited to lighting, sensing or actuation. This wireless power is delivered through the wall 162 of the water tank 114, and may also be transmitted through additional structure, including a wall 164 belonging to the transport column 122 and/or the humidifying module 112. Communication between the humidifying module 112 and the wireless power transmitter 140 in the transport column 122 may take place, and can happen over (on top of, as part of) the wireless power signal, or may be separate, or can take place optically, or through other wireless means (e.g. Bluetooth).

The humidifying modules applicable to the disclosed humidifier are ultrasonic (mechanical, piezoelectric, atomizer) and warm mist (heat), though the humidifying module could encompass any means for turning water into small droplets or vapor. For power to be transferred efficiently to the humidifying module 112, the relative X and Y axis positions of the humidifying module 112 are maintained and controlled with respect to the wireless power transmitter 140, and therefore, the transport column 122. And, for the humidifying module 112 to generate an optimal level of mist/water vapor, the Z position is maintained with respect to the water surface. With both the ultrasonic and warm mist humidifying modules, there is an optimal distance that a humidifying element 170, which is part of the humidifying module 112, is submerged below the surface of the water for maximum vapor production. For example, the optimal height from the surface of an ultrasonic transducer below the surface of the water may be in the 25-35 mm range, and the optimal height from the bottom-most surface of a submerged heating element to the surface of the water may be in the 5-50 mm range.

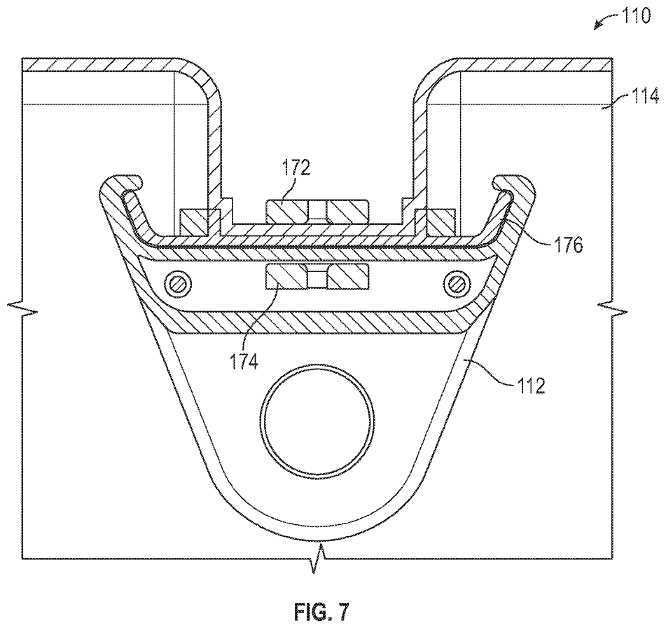

The humidifying module 112 can maintain its height with respect to the water level in different manners. The humidifying module 112 may be free-floating with the wireless power transmitter 140 sensing and the transport mechanism 138 adjusting the position of the wireless power transmitter 140 to follow the position of the humidifying module 112. In another embodiment, the water level in the water tank 114 is sensed and communicated to the controller 148, which then uses the transport mechanism 138 to set the wireless power transmitter 140 to the proper height, with a magnetically driven humidifying module 112 following. In the latter case and with reference to FIG. 7, the humidifier 110 includes a transport-side magnet 172 (permanent or electromagnetic) or magnetic element (e.g., steel) that cooperates with humidifying module-side magnet 174 (permanent or electromagnetic) on the humidifier module 112 and the magnetic force allows the humidifying module 112 to move up and down in the water tank 114 as the carriage 146 moves up and down. The transport-side magnet 172 can be located adjacent the wireless power transmitter 140 (FIG. 6), and the humidifying module-side magnet 174 can be located adjacent the wireless power receiver 142 (FIG. 6). The humidifying module 112 can be positioned properly with respect to the water level by sensing the water level. For example, this may be done electrically, capacitively, optically, or acoustically. The sensing may take place via a sensor positioned on the humidifying module 112 and that information can be communicated to the controller 148 through wireless means. The sensing may also take place through other means than on the humidifying module 112, and be communicated to the humidifying module 112 to properly position the humidifying module 112. For example, a water level sensor may be positioned on or in the transport column 112 and electrically connected with the controller 148. If the humidifying module 112 is driven magnetically to maintain its position with respect to the water level, in most configurations, this means that the forces are pulling the humidifying module 112 against the wall 162 of the water tank 114, creating friction and wear over time. Means of dealing with this are as follows: (1) low friction surfaces on the humidifying module 112 and/or on the water tank 114 where the humidifying module 112 engages with the water tank 114, (2) wheels or other rolling elements on the humidifying module 112, (3) counterposing magnetic forces that prevent full contact/forces between the humidifying module 112 and the tank wall 162. If the humidifying module 112 is free-floating, it can be made water-tight and providing the appropriate relative density, or specific gravity, so the humidifying module 170 sits at the optimal level with respect to the water level. As the water level drops (or rises, as water is added), the humidifying module 112 moves up and down as a result of its buoyancy. Via the controller 148, the wireless power transmission 140 circuitry then tracks the humidifying module 112 and optimally positions the transmission circuitry for the delivery of inductive power.

For power to be transferred efficiently from the wireless power transmitter 140 to the wireless power receiver 142 on the humidifying module 112, the X, Y and Z positions are controlled and maintained with respect to one another. If the wireless power transmitter 140 and wireless power receiver 142 are too far away in the X direction, or out of alignment in the Y and Z directions, this adversely impacts the efficiency of the power transmission. The Z position of the humidifying module 112 can be maintained with respect to the water level, either by floating, or by sensing the water level and driving the humidifying module 112 to the optimal depth by the transport mechanism 138 via magnetic forces. If the Z position is driven by the transport mechanism 138, via magnetic force, for example, then the humidifying module 112 is drawn toward the wireless power transmitter 140, and the X and Y positions with respect to the wireless power transmitter 140 become relatively fixed and maintained. If, however, the humidifying module 112 floats to maintain the Z position with respect to the water level, then there are no forces maintaining the X and Y positions between the wireless power transmitter 140 and the wireless power receiver 142 on the humidifying module 112. In this situation, referring to FIG. 7, a guide or track can be provided in the water tank. The guide or track 176 constrains the humidifying module 112 in the X and Y directions as well rotation around the X, Y and Z axes, but allows the humidifying module 112 to move freely (and therefore float) in the Z position. This guide or track 176 in the water tank 114 and associated features on the humidifying module 112, are designed to be easy to clean. If any vibration and/or noise is generated as a result of the operation of the unit and the space between the humidifying module 112 and the guide or track 176, a method of dealing with this is to provide some temporary electromagnetic force between the carriage 146 and the humidifying module 112, which can be turned off periodically to allow the humidifying module 112 to reestablish its position with respect to the water level.

If the humidifying module 112 is able to freely float, then the challenge of aligning the wireless power transmitter 140 to the wireless power receiver 142 on the floating humidifying module 112 arises. In an embodiment, the wireless power transmitter 140 is moved until it “sees” the humidifying module 112, by determining the level of inductive or reactive coupling. Measurable operating parameters on the transmitter side including voltage, current, and phase thereof can be used to determine when alignment between the wireless power transmitter 140 and humidifying module 112 is reached. The wireless power transmitter 140 moves up or down, operating at very low power, until it senses the presence of the wireless power receiver 142. The wireless power transmitter 140 will then move to optimize the inductive coupling and turn on at whatever power is required as determined by the settings. This “scanning” method of determining the position of the humidifying module 112 is intended to reduce stray electromagnetic fields and conserve power during situations when the wireless power transmitter 140 and the wireless power receiver 142 on the floating humidifying module 112 are not aligned. Another aspect of the scanning may include limiting power applied to the wireless power transmitter 140 by applying the working power to the wireless power transmitter 140 for a short duration instead of at a limited magnitude whereby the controller 148 is able to measure the inductive coupling of the link as if the wireless power transmitter 140 was operating at the target power level that is applied once alignment is determined.

By combining (1) the concept of a floating humidifying module 112, (2) the alignment of the wireless power transmitter 140 to the wireless power receiver 142 on the floating humidifying module 112 and (3) means of knowing the position of the wireless power transmitter 140 and/or the carriage 146, the water level in the water tank 114 can be determined. Some methods for knowing the position of the wireless power transmitter 140 and/or the carriage 146 include a limit switch 180 combined with a rotary or linear encoder, a linear encoder with means of knowing at least one fixed position, means for knowing one fixed position and counting steps (in the case of a stepper motor) or motor 160 revolutions, or estimating position via velocity and time. Knowing the water level can be useful for a variety of reasons, including prompting the user to add more water, knowing the output of the unit at a given setting, turning off the unit as the water level gets low, and controlling the output of the unit to reach some desired set point (e.g. making the water last 24 hours, putting out 2 gallons per day . . . etc.). In one embodiment, to limit the cost of components, the humidifier 110 is able to operate through all its modes using only a lower limit switch 180 along with step operation of the transport mechanism 138.

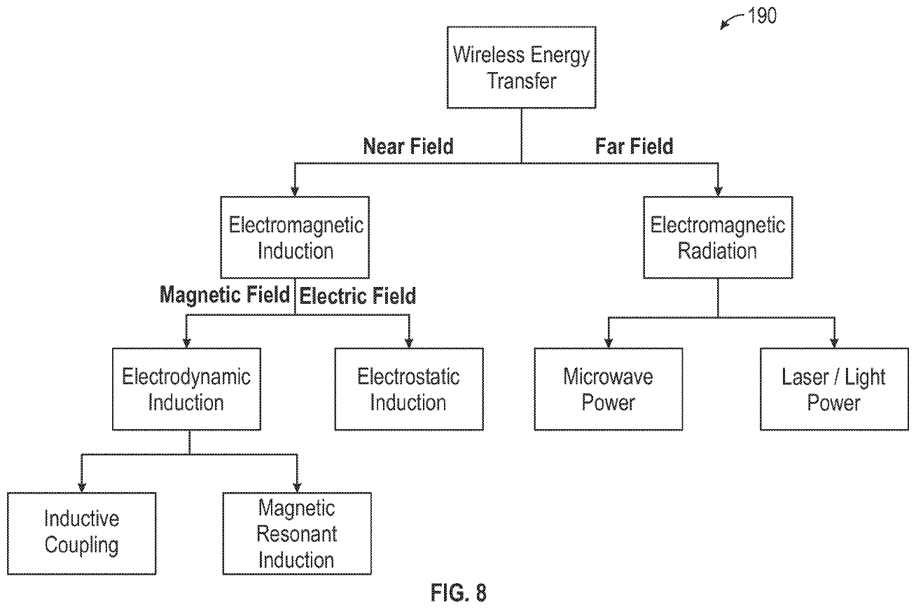

Referring to FIG. 8, as shown in the chart 190 there are a number of potential methods for wireless power transmission, each of which could be used to wirelessly transmit power from the wireless power transmitter 140 to the wireless power receiver 142 on the humidifying module 112. However, in practice, the one that is most suitable for this application is inductive coupling. With relatively inexpensive and small components, efficient power transfer can be achieved wirelessly, and through the plastic walls of the transport column 122, the water tank 114, the humidifying module 112, and air gaps between them.

Considering an ultrasonically based humidifying module 112, two possible approaches for power transfer will be discussed. The first is to transfer power inductively, and then to provide the appropriate circuitry in the humidifying module 112 to rectify that power, and produce a signal of sufficient amplitude and frequency to oscillate the transducer, e.g., the humidifying element 170, and atomize the water, thereby producing a mist. This means that the size and cost of the humidifying module 112 is directly impacted by requiring that all these electronics be included in the humidifying module 112. The second approach is to generate the signal to directly drive the transducer, e.g., the humidifying element 170, in the humidifying module 112 on the power transmission side, e.g., in the transport column 122, and inductively couple that signal through to the receiving side, e.g., in the humidifying module 112, thus reducing the required electronics in the humidifying module 112 to little other than a receiving coil. In one embodiment, a capacitor can be added on the receiver side in the humidifying module 112 to optimize the resonant coupling with impedance matching between transmitter and receiver sides to improve the efficiency of power transmission.

Directly driving the transducer signal through the inductive coils allows for the humidifying module 112 to be very small, very inexpensive and effectively a consumable that can be readily changed by the consumer. The transducers for humidifiers are a known weak point, and they can break or delaminate over time, reducing output. By simply replacing the humidifying module 112, a consumer can refresh the humidifier to original performance. This also means that the signal generating side of the electronics never gets close to the water, and therefore, needs no sealing or isolation, because the electronics are inside the transport column 112 (or base 124) of the humidifier 110.

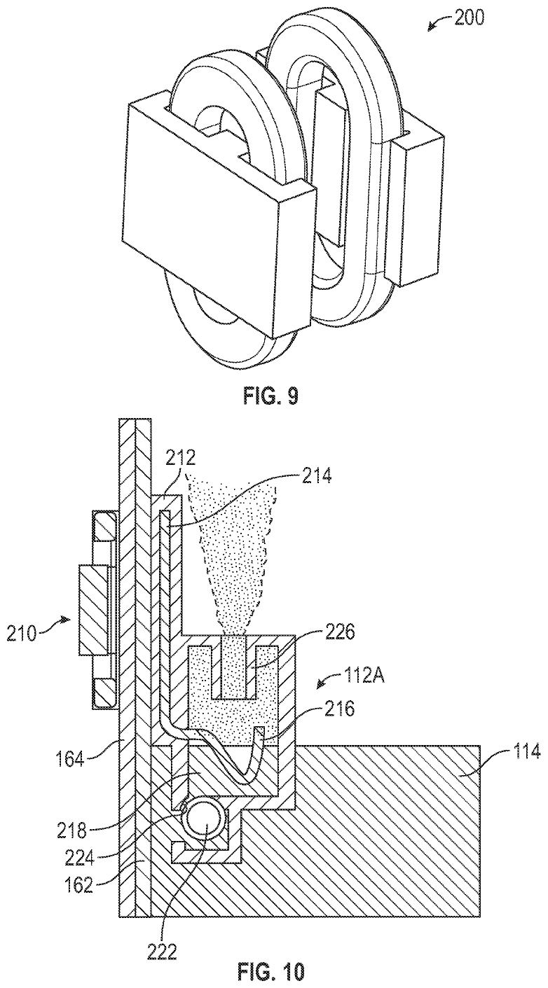

Directly driving the transducer signal through the inductive coils requires generation of magnetic energy at the operating frequency of the transducer, and this requires appropriate power coupling as well as magnetics capable of operating efficiently at the operating frequency. The efficiency of power transfer from power generating side to the power receiving side can be optimized by incorporating a transformer core on either the power generating side, the power receiving side, or both. When driving the ultrasonic transducer directly, the frequency required may be around 1700 KHz, and the transfer of energy through the generated magnetic flux is increased using ferromagnetic cores to channel the magnetic energy between the power generating and the power receiving circuits. Because of the high frequency, specialized core design and materials are utilized. It is not essential to include high frequency ferrite cores, but the practical size of the power coupling is reduced through their use, which makes other industrial design aspects of the system possible. The design of these cores is quite specialized for the application and their geometry is biased to inherently accommodate the practical aspects of the invention such as the X-Y-Z axis tolerances and misalignments that result in a physical system. FIG. 9 is an example of a primary and secondary ferrite core 200 (shown in classical “EE” configuration). The controller 148 (FIG. 6) can also determine a driving signal to the wireless power transmitter 140. The driving signal to the wireless power transmitter 140 can be a digital signal comprised of a non-sinusoidal waveform such as a square wave operating near or at the resonant frequency of the ultrasonic transducer, e.g., the humidifying element 170 in FIG. 6. Also, the driving signal can be changed or tuned during or after manufacturing.

Unlike an ultrasonic humidifying module, which requires a high frequency signal, a warm mist humidifying module only requires a hot element to locally heat water and turn it into water vapor or steam. The embodiment illustrated in FIG. 10 can provide that function through inductive (or induction) heating which relies on direct induction heating of ferrous materials, rather than relying on indirect radiation, convection, or thermal conduction. Induction heating allows high power and very rapid increases in temperature to be achieved, and changes in heat settings can be nearly instantaneous. To heat something inductively, a ferrous material is placed near a coil of copper wire with an alternating electric current passing through it. The resulting oscillating magnetic field wirelessly induces an electrical current in the ferrous material. This large “eddy current” flowing through the resistance of the vessel results in resistive heating. For induction heating, the heated element is made of a ferrous metal such as cast iron or some stainless steels. The iron concentrates the current to produce heat in the metal. If the metal is too thin, or does not provide enough resistance to current flow, heating will not be effective. Induction heating has good electrical coupling between the ferrous element and the coil and is thus quite efficient, which means it puts out less waste heat and it can be quickly turned on and off. Induction heating also has the advantage that non-ferrous surfaces stay cool and/or can be thermally isolated from the ferrous element. Another advantage of induction heating is a lower wireless transmission frequency, allowing easier construction and compliance with electromagnetic interference regulations.

Referring to FIG. 10, a power transmission coil 210 is placed in proximity to a warm mist humidifying module 112a. The warm mist humidifying module 112a is covered with a thermally insulative plastic material 212 and inside is a ferrous core 214, a large portion of which is proximal and parallel to the power transmission coil 210. An uninsulated portion 216 of the ferrous core 214 sits inside a boiling chamber 218 that fills, at least partially, with water, as the humidifying module 112a is partially submerged below the water surface. The inductive heating of the ferrous core 214 conducts heat to the uninsulated portion 216, where it then boils the water.

In one embodiment, the uninsulated portion 216 of the ferrous core 214 sits in a protected, insulated area, where heat generated by the ferrous core 214 and released to the water does not significantly heat the water in the rest of the tank. This has the benefit of (1) directing the heat to boil a small portion of water, instead of warming a large tank of water and (2) making sure that the surrounding water stays at a safe temperature.

In another embodiment, if/when a user removes the warm mist humidifying module 212a, the small amount of hot water around the uninsulated portion 216 of the ferrous core 214 immediately drains into the water tank 114, to reduce the likelihood that hot water can leak. One method to accomplish this is a floating ball 222, which restricts the flow of water into the boiling chamber 218 through a water inlet 224 when the warm mist humidifying module 112a is submerged, but drops and releases all water as soon as the warm mist humidifying module 112 is picked up out of the water. In yet another embodiment, the insulating material 212 defines a steam neck chimney-like structure 226 that prevents trapped hot water from spilling out if the warm mist humidifying module 112a is removed and tipped, but does allow for the release of steam during use. In yet another embodiment, the lid 116 to the water tank 114 can be locked for a predetermined period of time or until a certain temperature is reached, to prevent users from accessing the warm mist humidifying module 112a and the surrounding hot water.

In any embodiment, the power transmitted to the humidifying module 112, 112a can be turned off or reduced in a number of situations: a user tries to access the inside of the water tank 114 (indicated by a sensor), a user removes the humidifying module 112, 112a (determined by a change in inductive coupling), a user adds water, and the humidifier requires time to readjust and realign the wireless power transmitter 140 and the wireless power receiver 142.

In any embodiment, the mist must leave the water tank 114 to humidify the room. This can be accomplished a number of ways including passive and active manners. In a passive manner, the mist or steam releases on its own. In an active manner, a fan 250 pulls air and water vapor from the water tank 114. In another active manner, a fan 250 pushes fresh air into the water tank 114, forcing humidified air out of the water tank 114. This can be further optimized by forcing air down into the water tank 114, toward the humidifying module 112, 112a to encourage the moistest air out of the water tank 114. In another active manner, a fan (not shown) is powered by the wireless power circuitry, located on the humidifying module 112, 112a to cause air to circulate and exit.

Components can be added to the circuitry on the humidifying module 112, 112a to siphon power for other purposes or functions beyond the purpose of generating vapor. This includes lighting as a feature wherein the consumer is able to control the illumination, color, modes, etc. Such control further requires some control signal being transferred over the link between the controller 148 and the humidifying module 112, 112a. In one embodiment, the control signal is sent over the wireless link from the power generating side to the power receiving side along with the energy needed to power the humidifying module 112, 112a. Digital data is transmitted over the power coupling to a control circuit on the humidifying module 112, 112a such that lights can be controlled and or dimmed in the humidifying module 112, 112a in response to a settings input coming from the controller 148.

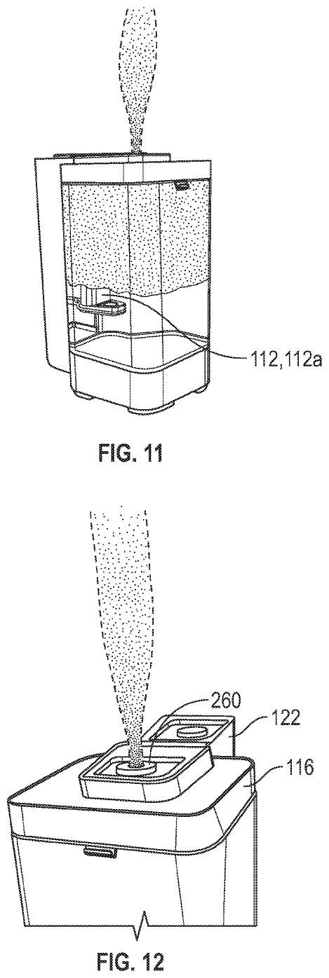

Wirelessly powered lighting can be provided both below the water, and above the water. The humidifying module lighting above the water level is very diffuse as a result of the atomized water or steam, and has the powerful visual effect of a glowing mist. It also provides a clear delineation of the water level, that can be seen across a room, so users know exactly where the water level is. Unlike the lighting above the water level, the lighting below the water level is very clear and crisp, and provides a visual indication that the unit is operating. Referring to FIG. 11, lighting in the humidifying module 112, 112a can clearly be seen below the water level, and the illuminated mist above it as depicted by the stippling in FIG. 11. The color, intensity and pattern of that light can also be adjusted to provide visual cues to the user about the mode of the humidifier. As mentioned, the control of this lighting can also take place wirelessly.

With transparent or semi-transparent walls in the transport column, lighting in the carriage 146, the part that moves up and down with the power, can also provide lighting. This “moving lighting” has the advantage of illuminating the mist portion of the water tank and the liquid water portion of the water tank separately, and as the water level drops, so too does the lighting, maintaining the separation between the above and below water lighting.

Because of the unique architecture of the humidifier, there is not a conventional chimney, or long plastic tube that extends from a lower water tray out of the top of the humidifier. Typically, this removable tank precludes the possibility of bringing lighting or electronics to the exit of the mist. Instead, in the illustrative humidifier, there is only a single water tank. As such, this architecture lends itself to unique lighting, where electronics and LEDs 260 can be placed in the lid 116, which is directly connected to the transport column, which houses virtually all the electronics. Referring to FIG. 12, the illumination (depicted by stippling in FIG. 12) of the exit plume is clearly demonstrated. Lighting to a separable lid can be achieved through contacts between the transport column 122 and the lid 116, or by inductively transferring power from the transport column 122 to the lid 116. Lighting can also be brought to the lid through the use of light pipes.

The embodiments described herein provide a new architecture for humidifiers and solves a number of important consumer problems. The net effect of this new architecture is a dramatically simpler, easier to clean, elegant design with minimal chance for leakage or dripping. The descriptions are focused on the ultrasonic (cool mist) embodiment of the invention, but the same approach with a few modifications makes it appropriate for warm mist technology as well. It will be appreciated that various of the above-disclosed embodiments and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A humidifier comprising:
a water tank;
a humidifying module positionable in the water tank, the humidifying module including a wireless power receiver and at least one of an ultrasonic transducer and a heating element in electrical communication with the wireless power receiver;
a wireless power transmitter configured to wirelessly transmit electrical power through a wall of the water tank to the wireless power receiver; and
a transport mechanism configured to move the wireless power transmitter with respect to the water tank.

2. The humidifier of claim 1, further comprising a housing including a transport column, wherein the transport mechanism is at least partially disposed in the transport column.

3. The humidifier of claim 2, wherein the housing includes a base connected with the transport column, wherein the water tank is positioned on the base when the humidifier is in use generating water vapor.

4. The humidifier of claim 3, wherein the transport mechanism includes a motor positioned in at least one of the base and the transport column.

5. The humidifier of claim 1, further comprising a rotatable or removable lid that includes a vapor exit opening, the lid selectively covering the water tank and contacting an upper edge of the water tank when covering the water tank.

6. The humidifier of claim 1, wherein the transport mechanism includes at least one of a belt, a cable, gear rack and a screw configured for moving the wireless power transmitter along a vertical axis with respect to the water tank.

7. The humidifier of claim 6, wherein the transport mechanism includes a motor operably connected with the at least one of the belt, the cable, gear rack and the screw.

8. The humidifier of claim 1, wherein the transport mechanism includes include means for determining at least one position of the wireless power transmitter along a vertical axis.

9. The humidifier of claim 1, further comprising a carriage carried by the transport mechanism, wherein the wireless power transmitter is fixed to so as to move along with the carriage with respect to the water tank.

10. The humidifier of claim 1, further comprising a transport-side magnetic component connected with the transport mechanism and configured to move with respect to the water tank, and a humidifying module-side magnetic component associated with the humidifying module, wherein the transport-side magnetic component cooperates with the humidifying module-side magnetic component to move the humidifying module to move up and down in the water tank.

11. (canceled)

12. The humidifier of claim 1, further comprising a water level sensor, wherein the water level sensor is positioned on the humidifying module and the water level sensor is configured to wirelessly transmit signals to a controller, which is in electrical communication with the wireless power transmitter.

13. The humidifier of claim 1, further comprising a water level sensor, wherein the water level sensor is positioned on or in a transport column that houses at least a portion of the transport mechanism.

14. The humidifier of claim 1, wherein the humidifying module is configured to float in water.

15. The humidifier of claim 14, further comprising a controller in electrical communication with the wireless power transmitter, wherein the controller controls the transport mechanism to move the wireless power transmitter while sensing for the wireless power receiver.

16. The humidifier of claim 14, further comprising a controller in electrical communication with the wireless power transmitter, wherein the controller is configured to determine a water level in the water tank based on determining alignment of the wireless power transmitter to the wireless power receiver.

17. The humidifier of claim 16, wherein the controller is configured to determine a water level in the water tank based on determining a position of the wireless power transmitter.

18. The humidifier of claim 16, further comprising at least one of a limit switch and an encoder, wherein the controller is configured to determine the position of the wireless power transmitter based on signals received from the at least one of the limit switch and the encoder.

19. The humidifier of claim 16, wherein the controller is configured to determine the position of the wireless power transmitter based on a known fixed position and counting steps or revolutions or estimating position via velocity and time.

20. The humidifier of claim 1, wherein the water tank includes a guide or track and the humidifying module engages the guide or track to maintain a positional relationship with respect to the wireless power transmitter while allowing for vertical movement of the humidifying module with respect to the water tank.

21. The humidifier of claim 1, wherein the humidifying module includes the ultrasonic transducer and circuitry configured to rectify inductively received power from the wireless power transmitter and to produce a signal of sufficient amplitude and frequency to oscillate the ultrasonic transducer and atomize water.

22. The humidifier of claim 1, wherein the humidifying module includes the ultrasonic transducer and the wireless power transmitter is configured to generate a signal of sufficient amplitude and frequency to oscillate the ultrasonic transducer and atomize water.

23. The humidifier of claim 22, wherein the humidifying module includes a capacitor configured to optimize impedance to a resonant frequency of the ultrasonic transducer.

24. The humidifier of claim 1, wherein the wireless power transmitter includes a first inductive coil, and the humidifying module includes a second inductive coil.

25. The humidifier of claim 24, further comprising a transformer core associated with at least one of the wireless power transmitter and the humidifying module.

26. (canceled)

27. The humidifier of claim 1, further comprising a controller in electrical communication with the wireless power transmitter and the transport mechanism, wherein the controller is configured to control movement of the wireless power transmitter and to sense for the presence of the wireless power receiver.

28. The humidifier of claim 27, wherein the controller is configured to operate the transport mechanism to move the wireless power transmitter while operating at a lower power as compared to a working power, which is when the wireless power transmitter is operating to drive the at least one of the ultrasonic transducer and the heating element, while sensing for the presence of the wireless power receiver.

29. The humidifier of claim 27, wherein the controller is configured to operate the transport mechanism to move the wireless power transmitter and apply a working power, which is the power at which the wireless power transmitter is operating to drive the at least one of the ultrasonic transducer and the heating element, for a predefined time duration while sensing for the presence of the wireless power receiver.

30. The humidifier of claim 1, wherein humidifying module includes the heating element and a valve that restricts the flow of water into a boiling chamber when the humidifying module is submerged in water, and opens to release water when the humidifying module is picked up out of the water.

31. The humidifier of claim 1, wherein humidifying module includes the heating element and a steam neck chimney-like structure that prevents trapped hot water from spilling out of a boiling chamber if the humidifying module is removed from the water and tipped, while allowing for the release of steam during use.

32. The humidifier of claim 1, wherein humidifying module includes the heating element and the humidifier further comprising a lid on the water tank and a lid locking mechanism that is operable to a locked state in which the lid to the water tank is locked to the water tank for a predetermined period of time or until a certain temperature of water within the humidifying module is reached.

33. (canceled)

34. The humidifier of claim 33, further comprising a light in electrical communication with the wireless power transmitter, wherein the wireless power transmitter is configured to wirelessly deliver control signals to the light.

35. (canceled)

36. The humidifier of claim 35, wherein the controller determines a driving signal to the wireless power transmitter, wherein humidifying module includes the ultrasonic transducer, and the driving signal to the wireless power transmitter is comprised of a non-sinusoidal waveform such as a square wave operating near or at the resonant frequency of the ultrasonic transducer.
